(19) United States
(12) Patent Application Publication
(10) Pub. No.: US 2008/0004056 A1
(43) Pub. Date: Jan. 3, 2008

(54) Methods and systems for incorporating a voice-attached, tagged rich media package from a wireless camera-equipped handheld mobile device into a collaborative workflow

(76) Inventor: Paul Suzman, Seattle, WA (US)

Correspondence Address: OLYMPIC PATENT WORKS PLLC, P.O. BOX 4277, SEATTLE, WA, 98104, US

(21) Appl. No.: 11/809,775

(22) Filed: Jun. 1, 2007

Related U.S. Application Data
(60) Provisional application No. 60/810,510, filed on Jun. 1, 2006.

(51) Int. Cl. H04Q 7/20

(52) U.S. Cl. 455/466

(57) ABSTRACT

Various embodiments of the present invention are directed to methods and systems for incorporating a voice-attached, tagged rich media package from a wireless camera-equipped handheld mobile device into a collaborative workflow. In one embodiment of the present invention, a user's wireless camera-equipped handheld mobile device transmits, to a workflow server, a voice-attached, tagged rich media package that includes visual media, a voice signal, and one or more user-selected tags. The voice-attached, tagged rich media package is transmitted to a transcribing system and the voice signal is transcribed and merged with the voice-attached, tagged rich media package to create a voice-attached, tagged, transcribed rich media package. The voice-attached, tagged, transcribed rich media package is subsequently transferred back to the workflow server for storage. Once stored, the voice-attached, tagged, transcribed rich media package is made accessible to a user and user-authorized third parties for collaborative review and revision.

### CROSS-REFERENCE TO RELATED APPLICATION

This application claims the benefit of Provisional Application No. 60/810,510, filed Jun. 1, 2006.

### TECHNICAL FIELD

The present invention is related to wireless camera-equipped handheld mobile devices, and, in particular, to methods and systems for incorporating a voice-attached, tagged rich media package from a wireless camera-equipped handheld mobile device into a collaborative workflow.

### BACKGROUND OF THE INVENTION

Mobile devices, personal data assistants, smartphones, and other camera-equipped wireless handheld mobile devices (“mobile devices”) have been widely adopted by consumers. Such mobile devices allow for mobile-device users to communicate rich media packages over wireless networks. In addition to voice signals, a number of different types of visual media may be part of a rich media package, including digital images, animation, video recordings, and other types of visual media. Many currently-manufactured mobile devices are also equipped with various other features, including Internet access, MP3 players, and global-positioning-device capabilities.

Mobile devices have facilitated news gathering and event reporting, intimate personal communications, in which visual media can elicit a wider range of emotional responses than voice signals alone, and business-related and research-related information transfer. Additionally, voice signals may be used to describe a particular piece of visual media and to provide background information or lead-in information to the particular piece of visual media in real time or near real time. However, currently, it is difficult for users to manage the transfer of rich media packages from mobile devices. Users, retailers, designers, and manufacturers of mobile devices have, therefore, recognized a need for easier, more intuitive and more robust methods for managing the transfer of rich media from mobile devices.

### SUMMARY OF THE INVENTION

Various embodiments of the present invention are directed to methods and systems for incorporating a voice-attached, tagged rich media package from a wireless camera-equipped handheld mobile device into a collaborative workflow. In one embodiment of the present invention, a user's wireless camera-equipped handheld mobile device transmits, to a workflow server, a voice-attached, tagged rich media package that includes visual media, a voice signal, and one or more user-selected tags. The voice-attached, tagged rich media package is transmitted to a transcribing system and the voice signal is transcribed and merged with the voice-attached, tagged rich media package to create a voice-attached, tagged, transcribed rich media package. The voice-attached, tagged, transcribed rich media package is subsequently transferred back to the workflow server for storage. Once stored, the voice-attached, tagged, transcribed rich media package is made accessible to a user and user-authorized third parties for collaborative review and revision.

### BRIEF DESCRIPTION OF THE DRAWINGS

FIG. 1 shows a schematic diagram of a system for transferring a rich media package from a mobile device to a collaborative workflow that represents one embodiment of the present invention.

FIG. 2A shows a first exemplary on-line registration page for a user desiring to register for use of a rich-media-transfer system that represents one embodiment of the present invention.

FIG. 2B shows a second exemplary on-line registration page for a user desiring to set up a user account for use of a rich-media-transfer system that represents one embodiment of the present invention.

FIG. 2C shows a third exemplary on-line registration page for a user desiring to set up a user account for use of a rich-media-transfer system that represents one embodiment of the present invention.

FIG. 2D shows a fourth exemplary on-line registration page for a user desiring to set up a user account for use of a rich-media-transfer system that represents one embodiment of the present invention.

FIG. 3A shows an exemplary browse-pictures screenshot on a mobile device that represents one embodiment of the present invention.

FIG. 3B shows an exemplary screenshot of a selected saved image from a number of saved images on a mobile device that represents one embodiment of the present invention.

FIG. 4A shows a first exemplary add-a-voice-message screenshot on a mobile device that represents one embodiment of the present invention.

FIG. 4B shows a second exemplary add-a-voice-message screenshot on a mobile device that represents one embodiment of the present invention.

FIG. 4C shows a third exemplary add-a-voice-message screenshot on a mobile device that represents one embodiment of the present invention.

FIG. 5 shows an exemplary select-a-tag screenshot on a mobile device that represents one embodiment of the present invention.

FIG. 6 shows an exemplary confirmation screenshot confirming the transmission of a rich media package from a mobile device that represents one embodiment of the present invention.

FIG. 7 shows an exemplary on-line personal-account page containing a listing of transcribed rich media packages that represents one embodiment of the present invention.

FIG. 8 shows a control-flow diagram of exemplary steps for a workflow server in a system for transferring a rich media package from a mobile device to a collaborative workflow that represents one embodiment of the present invention.

FIG. 9 shows an exemplary on-line personal-account page containing user-selected template options for use with transcribed rich media packages that represents one embodiment of the present invention.

FIG. 10 shows an exemplary on-line personal-account page containing user-selected destination options for uploading transcribed rich media packages that represents one embodiment of the present invention.

FIG. 11 shows an exemplary on-line personal-account page containing user-changeable account attributes that represents one embodiment of the present invention.

FIG. 12 shows an exemplary on-line personal-account page that a user may use to print selected transcribed rich media packages and that represents one embodiment of the present invention.

FIG. 13 shows an exemplary on-line personal-account page that enables a user to search for selected transcribed rich media packages and that represents one embodiment of the present invention.

### DETAILED DESCRIPTION OF THE INVENTION

Various embodiments of the present invention are directed to methods and systems for incorporating a voice-attached, tagged rich media package from a mobile device into a collaborative workflow. In one embodiment of the present invention, a mobile-device user (“user”) selects visual media available on the mobile device and creates a voice signal by recording a dictation into the mobile device. The user may then select and attach a tag to the visual media and associated voice signal from a user-selected list of tags. Collectively, the visual media, voice signal, and tag form a voice-attached, tagged rich media package (“rich media package”). The rich media package is transmitted to a transcription service where the voice signal is transcribed and merged with the rich media package, thus forming a voice-attached, tagged, transcribed rich media package (“transcribed rich media package”). The transcribed rich media package is then transmitted to a workflow server for storage. In various embodiments of the present invention, the user and user-authorized third parties are provided access to the transcribed rich media package for collaborative review and revision.

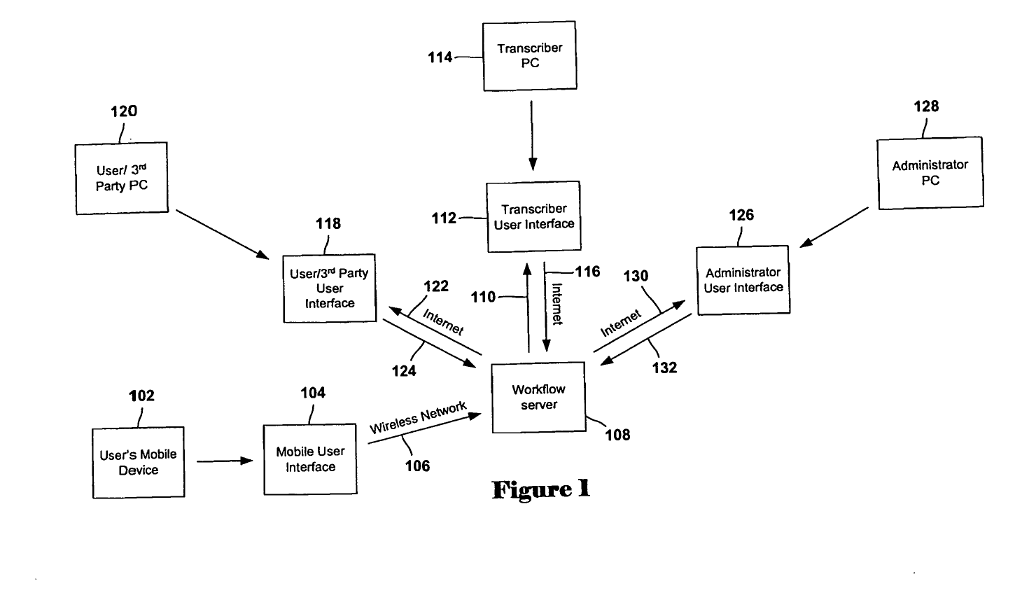

FIG. 1 shows a schematic diagram of a system for transferring a rich media package from a mobile device to a collaborative workflow that represents one embodiment of the present invention. As shown in FIG. 1, a user's mobile device 102, via a mobile user interface 104, transmits a rich media package, via a wireless communications network 106, to a workflow server 108. The rich media package includes a voice-signal file, one or more associated visual-media files, and one or more user-created tags. A transcription service uses a transcriber user interface 112 on a transcriber personal computer (“PC”) 114 to access 110 the rich media package on the workflow server 108 and transcribes the voice signal in the rich media package. The transcriber merges the transcription to the rich media package and transmits 116 the transcribed rich media package, via the Internet, back to the workflow server 108 where the transcribed rich media package is stored. A user may use a user user interface 118 on a user PC 120 to access 122 the transcribed rich media package. Additionally, one or more user-authorized third parties may also use a third party user interface on a third party PC to access the transcribed rich media package. A user may also transmit 124 information to an administrator via the workflow server 108, for example, when setting up a user account.

An administrator may use an administrator user interface 126 on an administrator PC 128 to download 130 information on the workflow server 108 and/or to upload 132 information to the workflow server 108. For example, an administrator may receive a request from a user to change his or her billing information, or the administrator may input a number of different types of administrative information to the workflow server 108, such as setup and configuration information, security, and other administrative information.

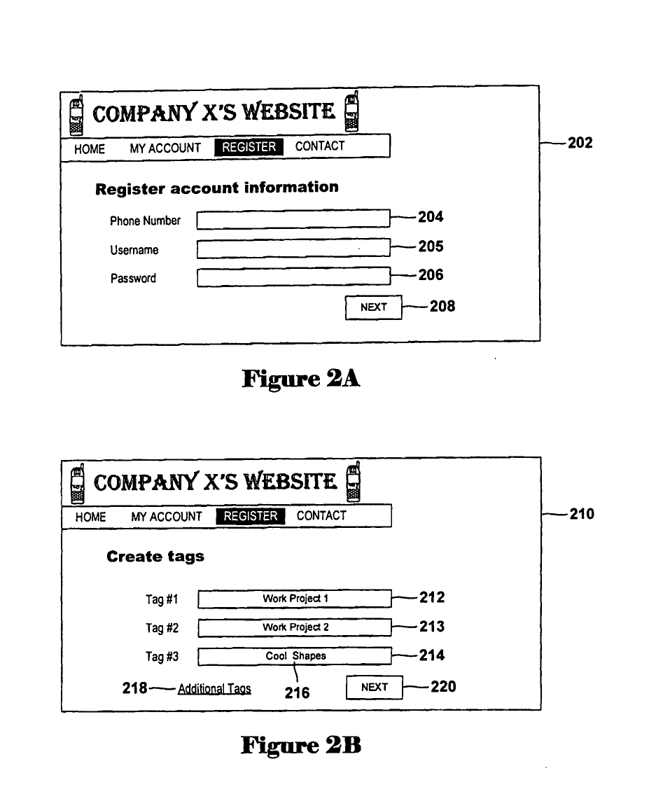

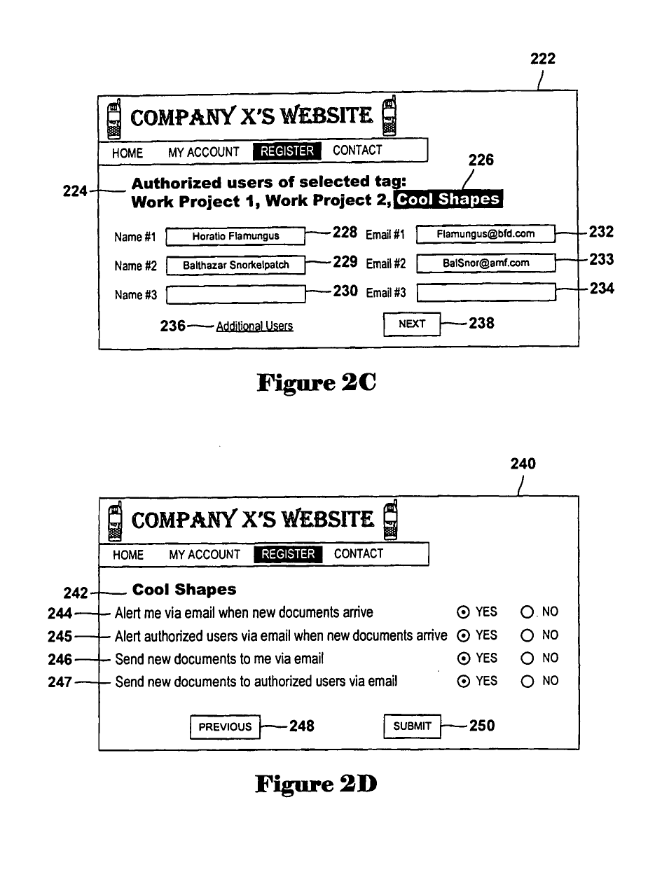

In one embodiment of the present invention, a user may access a rich-media-transfer-system website to set up a user account for use of a rich-media-transfer system that is operable on his or her mobile device. FIG. 2A shows a first exemplary on-line registration page for a user desiring to set up a user account for use of a rich-media-transfer system that represents one embodiment of the present invention. In FIG. 2A, a first on-line registration page 202 for setting up a user account with Company X for use of a rich-media-transfer system is shown. Three fields 204, 205, and 206 enable a user to type in personal information regarding a phone number, username, and password, respectively. A NEXT button 208, when pressed, enables a user to exit the first on-line registration page 202 and move to the next on-line registration page after typing in the personal information in fields 204-206. In alternate embodiments of the present invention, additional information is requested from a user, including a name, address, payment information, market-survey information, and other retail-related information.

FIG. 2B shows a second exemplary on-line registration page for a user desiring to set up a user account for use of a rich-media-transfer system that represents one embodiment of the present invention. In FIG. 2B, a second on-line registration page 210 for setting up a user account with Company X for use of a rich-media-transfer system is shown. Three fields 212, 213, and 214 enable a user to type in headings for tags that may be used for identification and/or organizational purposes. In one embodiment of the present invention, input tags, such as input tag 216, provide key words that may subsequently be used in a key-word search to locate a specific transcribed rich media package, or a specific sub-class of transcribed rich media packages. In FIG. 2B, a user has typed “Work Project 1” in field 212, “Work Project 2” in field 213, and “Cool Shapes” in field 214. An additional-tag link 218, when selected, enables a user to create additional tags, if desired. A NEXT button 220, when pressed, enables a user to exit the second on-line registration page 210 and move to the next on-line registration page after typing in desired tags in one or more of the fields 212-214.

FIG. 2C shows a third exemplary on-line registration page for a user desiring to set up a user account for use of a rich-media-transfer system that represents one embodiment of the present invention. In FIG. 2C, a third on-line registration page 222 for setting up a user account with Company X for use of a rich-media-transfer system is shown. A user-selected tag 224 enables a user any of the tags created in the second on- line registration page 210. In FIG. 2C, a user has selected the tag “Cool Shapes” 226. Three name fields 228, 229, and 230 enable a user to type in the names of third parties who are authorized to access selected rich media packages, such as rich media packages designated by a specific tag. In FIG. 2C, a user has typed in the name “Horatio Flamungus” in name field 228 and “Balthazar Snorkelpatch” in name field 229. Thus, Horatio Flamungus and Balthazar Snorkelpatch have been authorized to access transcribed rich media packages with a “Cool Shapes” tag.

Three email address fields 232, 233, and 234 enable a user to type in the names of the addresses of authorized third parties. An additional-name link 236, when selected, enables a user to input additional names and emails of authorized third parties, if desired. Note that a user need not authorize any third parties to access transcribed rich media packages. A user may simply select a tag from the user-created listing 224 of tags and leave the fields 228-230 and 232-234 blank. A NEXT button 238, when pressed, enables a user to exit the third on-line registration page 222 and move to the next on-line registration page.

FIG. 2D shows a fourth exemplary on-line registration page for a user desiring to set up a user account for use of a rich-media-transfer system that represents one embodiment of the present invention. In FIG. 2D, a fourth on-line registration page 240 for setting up a user account with Company X for use of a rich-media-transfer system is shown. A heading 242, displays the currently-selected tag, selected in the third on-line registration page (22 in FIG. 2C). Yes/No questions 244 and 245 enable a user to control how the user and user-authorized third parties are alerted when incoming transcribed rich media package are stored on a workflow server. The user may click on either a “YES” or a “NO” circle to respond to yes/no questions 244 and 245. Yes/no questions 246 and 247 enable a user to decide whether the user and user-authorized third parties are to receive new transcribed rich media package as an attachment via email and/or whether the user and user-authorized third parties need to access the rich-media-transfer-system website to access new transcribed rich media packages. The user may click on either a “YES” or a “NO” circle to respond to yes/no questions 246 and 247. In FIG. 2D, a user has selected “YES” for each of yes/no questions 244-247. A PREVIOUS button 248, when pressed, enables a user to return to the previous on-line registration page (222 in FIG. 2C) to provide access information for other tags. A SUBMIT button 250, when pressed, enables a user to exit the fourth on-line registration page 240 when either a “YES” or “NO” selection is made for each yes/no question 244-247 and sends the input information from on-line registration pages 202, 210, 222, and 240 to a workflow server and/or an administrator for processing. Note that the information entered into the on-line registration pages, 202, 210, 222, and 240 may subsequently and repeatedly be changed by a user during the management of an active user account.

Once a user has completed entering the requested information, an administrator may review the information and authorize the creation of a user account. In one embodiment of the present invention, rich-media-transfer software is pre-installed onto a mobile device. The mobile-device-rich-media-transfer software (“mobile transfer software”) may include predefined options, such as user passwords or biometrics, such as voice recognition and/or fingerprint-scanning software. The mobile transfer software may be integrated with other software operating on a mobile device that enables rich media packages created on a mobile device to be transferable from the mobile device to a workflow server. The mobile transfer software may be configured with the address of the workflow server, in order to route rich media packages to the workflow server.

In one embodiment of the present invention, the mobile transfer software automatically starts when a user powers on a mobile device. After turning on the mobile device, the user may generate visual media, for example, by snapping a number of pictures with a mobile device. Generated visual media may be written to a file system located on the mobile device's internal persistent memory (internal or on a memory card). In alternate embodiments of the present invention, visual media are imported from other electronic devices, such as a PC or other electronic device.

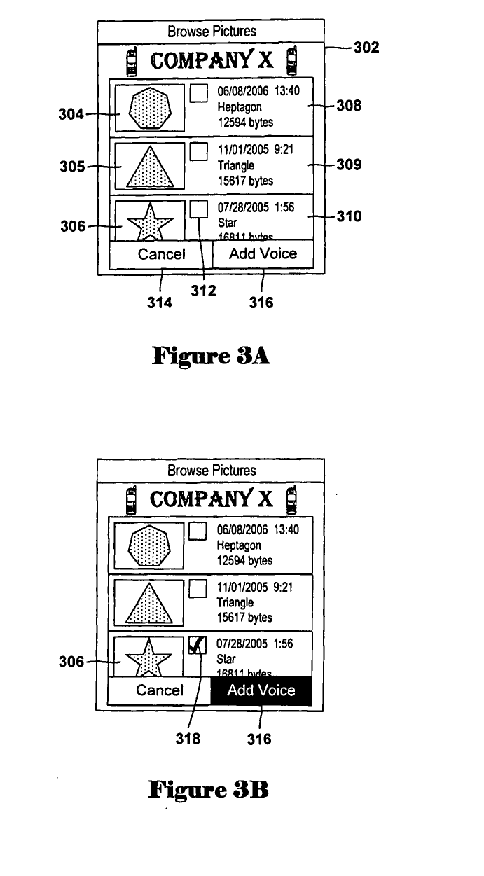

FIG. 3A shows an exemplary browse-pictures screenshot on a mobile device that represents one embodiment of the present invention. A browse-pictures screenshot 302 includes three saved images 304, 305, and 306, and three sets of image-related information 308, 309, and 310, respectively. The image-related information 308-310 includes the date and time each of the saved images was snapped, a name for each of the saved images, and the size of each corresponding file. The image-related information 308-310 also contains a selection box for each saved image, such as selection box 312. A CANCEL button 314, when pressed, enables a user to opt out of selecting a saved image and an ADD VOICE button 316, when pressed, enables a user to add a voice signal for subsequent attachment once one or more saved images are selected.

FIG. 3B shows an exemplary screenshot of a selected saved image from a number of saved images on a mobile device that represents one embodiment of the present invention. In FIG. 3B, a checkmark 318 indicates that a user has selected saved image 306. The user has also pressed the ADD VOICE button 316 to add a voice signal. In alternate embodiments of the present invention, the user selects a voice-signal-addition option by emitting a particular voice command, or by some other action.

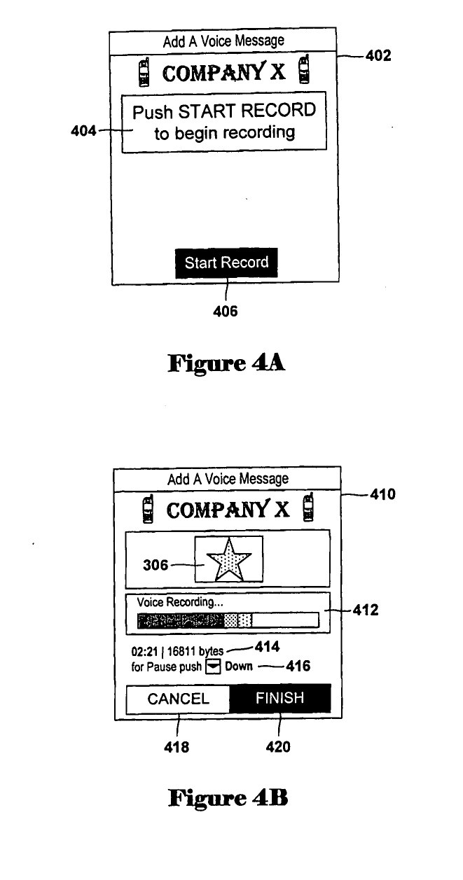

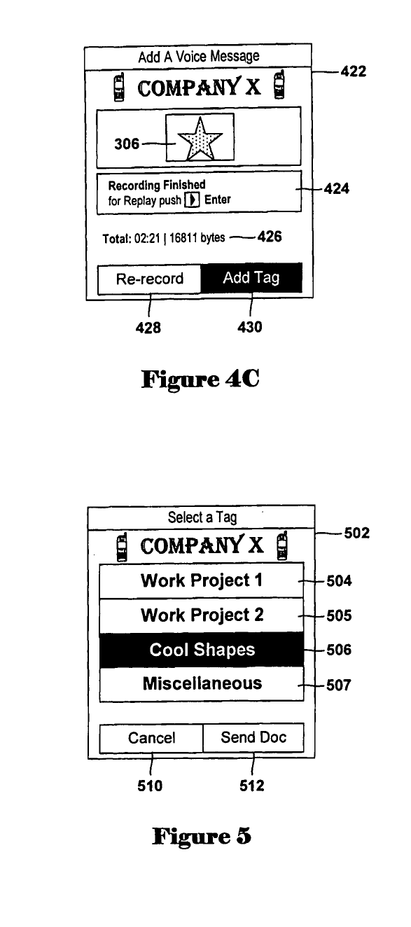

FIG. 4A shows a first exemplary add-a-voice-message screenshot on a mobile device that represents one embodiment of the present invention. A first add-a-voice-message screenshot 402 includes an instruction 404 instructing the user to press a START RECORD button 406 to begin creating a voice signal by, for example, recording a dictation. In FIG. 4A, a user has pressed the START RECORD button 406 to add a dictation to the saved image selected above, in FIG. 3B.

FIG. 4B shows a second exemplary add-a-voice-message screenshot on a mobile device that represents one embodiment of the present invention. A second exemplary add-a-voice-message screenshot 410 includes the saved image 306 selected in FIG. 3B, a recording indicator 412 showing how much time has elapsed during a current dictation, dictation-related information 414, and a pause button 416 to enable a user to pause during a dictation when the pause button 416 is pressed. The dictation-related information 414 includes the current length (in time) of the dictation and the size (in kB) of the file. A CANCEL button 418, when pressed, enables a user to cancel the dictation. A FINISH button 420, when pressed, enables a user to end the recording when the user is finished dictating. When the FINISH button 420 is pressed, a third add-a-voice-message screenshot is pulled up. In alternate embodiments of the present invention, a user may end a dictation by emitting a particular voice command, exceeding a time-limit threshold, or some other action. In FIG. 4B, a user has pressed the FINISH button 420.

Once a user creates a dictation, the dictation is processed and temporarily saved on the mobile device. FIG. 4C shows a third exemplary add-a-voice-message screenshot on a mobile device that represents one embodiment of the present invention. A third exemplary add-a-voice-message screenshot 422 includes the saved image 306 selected in FIG. 3B, a replay button 424 to enable a user to listen to the dictation when the replay button 424 is pressed, and information 426 about the size (in kB) and time-length of the dictation. A RE-RECORD button 428, when pressed, enables a user to record over the previous dictation. An ADD TAG button 430, when pressed, enables a user to select one or more of the user-created tags discussed above, with reference to FIG. 2B. In FIG. 4C, a user has selected the ADD TAG button 430 to select a tag for the dictation and associated saved image 306.

FIG. 5 shows an exemplary select-a-tag screenshot on a mobile device that represents one embodiment of the present invention. A select-a-tag screenshot 502 includes four user-created tags 504-507, as discussed above with reference to FIG. 2B. In FIG. 5, a user has selected the “Cool Shapes” tag 506. A CANCEL button 510, when pressed, enables a user to cancel a tag assignment. A SEND DOC button 512, when pressed, enables a user to transmit the voice signal, the saved image (306 in FIG. 3A), and the selected tag to a workflow server.

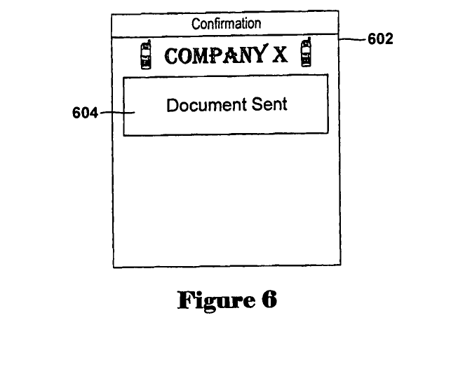

FIG. 6 shows an exemplary confirmation screenshot confirming the transmission of a rich media package from a mobile device that represents one embodiment of the present invention. A confirmation screenshot 602, when selected, includes a message confirming the transmission of the voice signal, the saved image (306 in FIG. 3A), and the associated tag. Note that, in FIGS. 3A-6 a saved digital-camera image was used as an example of a visual medium. In alternate embodiments, other types of visual media besides digital images are incorporated into a rich media package, including animation, video recordings, and other types of visual media. Note also that, in FIGS. 3A-6 a single saved image and a single tag were selected. In alternate embodiments of the present invention, visual media and multiple tags may be selected.

In one embodiment of the present invention, the voice signal is written to the file system on the mobile device's internal persistent memory. The mobile transfer software becomes aware of the rich media package, for example, by regularly polling the file system on the camera-equipped mobile device looking for rich media packages. When a new rich media package is detected, the mobile transfer software instructs the mobile device's preinstalled mobile transfer software to transfer the rich media package to the workflow server over a wireless network. The rich media package may include unique indicators of the originating camera-equipped mobile device, such as the phone number of the camera-equipped mobile device.

Once a rich media package is transferred to a workflow server, the workflow server prompts the transcriber PC and the transcription service downloads the rich media package from the workflow server. In one embodiment of the present invention, a workflow server places a rich media package in a directory named by a unique indicator of the mobile device. A transcriber PC includes PC transfer software for downloading rich media packages from the workflow server. The PC transfer software may be started when the transcriber PC is powered on, or when the transcriber is logged into the transcriber PC. To download files, the PC transfer software connects to the workflow server, for example via a file transfer protocol (“FTP”). The PC transfer software may poll the workflow server periodically to check for new rich media packages in the various directories for mobile devices on the workflow server. When rich media packages are found, the rich media packages may be saved to a particular place on the transcriber PC, such as an Incoming-Client-Transcription file.

After a transcription service receives a rich media package from a workflow server on a transcriber PC, a transcriber transcribes the voice-signal file and merges the voice-signal file with the visual-media files and associated tags to form a transcribed rich media package. In alternate embodiments of the present invention, the transcription may be performed by a transcriber or by voice-recognition software. Upon completion of the transcription, the transcribed rich media package is transmitted back to the workflow server for storage.

Once a transcribed rich media package is stored on a workflow server, several different user-selected options may exist with regard to notifying a user and user-authorized third parties, as discussed above with reference to FIG. 2D. Additionally, several different options may exist with regard to how a user and user-authorized third parties may access a transcribed rich media package, as also discussed above with reference to FIG. 2D. In one embodiment of the present invention, a user may opt to have an email sent to the user and any user-authorized third parties. The email includes an attachment that contains the transcribed rich media package. In various embodiments of the present invention, the attachment may be sent as a file in various possible formats, including a Word file, a PDF file, an Excel file, or other possible file format. Once received, a transcribed rich media package may be reviewed and revised by either the user or any of the user-authorized third parties and transmitted back and forth between each of the parties, as needed.

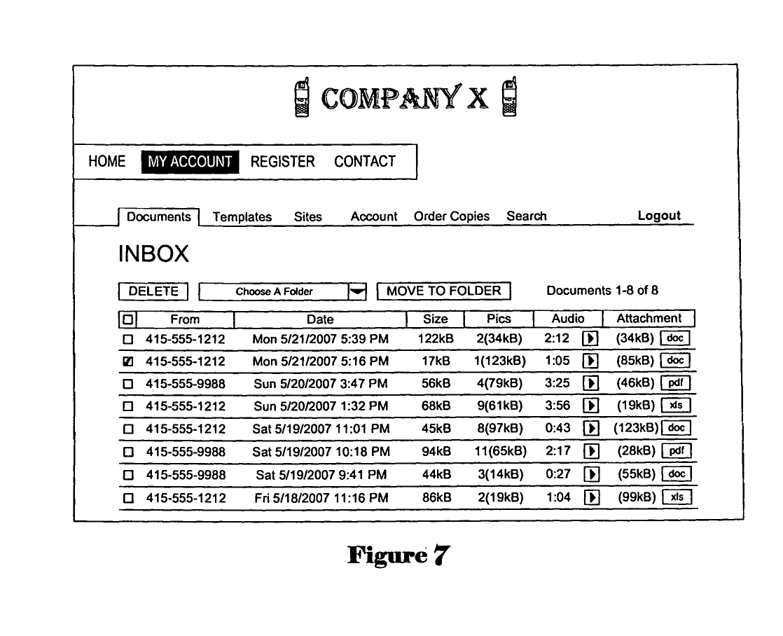

In another embodiment of the present invention, a user may opt to have an email sent to the user and any user-authorized third parties that alerts each of the parties of an incoming transcribed rich media package. The user may then logon to his or her user account on the rich-media-transfer-system website discussed above, with reference to FIGS. 2A-2D. Once logged on, a user may access an inbox containing a listing of new and/or saved transcribed rich media packages. FIG. 7 shows an exemplary on-line personal-account page containing a listing of transcribed rich media packages that represents one embodiment of the present invention. A user may access any of the listed transcribed rich media packages, review an accessed transcribed rich media package, make revisions as needed, and send the revisions to selected parties via email. Additionally, each of the user-authorized third parties may visit the rich-media-transfer-system website and login using the name and/or email address provided by the user and discussed above, with reference to FIG. 2C. Alternately, a user-authorized third party may login using a provided name and/or password allowing the user-authorized third party access to either a particular transcribed rich media package or a particular sub-class of transcribed rich media packages, such as any transcribed rich media package containing a “Cool Shapes” tag, as discussed above with reference to FIGS. 2B-2D and 5. By either method, the user-authorized third party is only given access to certain transcribed rich media packages selected by the user. Once a user-authorized third party is logged in, the user-authorized third party may access the available transcribed rich media package, review the transcribed rich media package, make revisions as needed, and send the revisions to selected parties via email. In yet another embodiment of the present invention, a user may opt to have an email sent only to the user alerting the user of a new transcribed rich media package. The user may login to his or her user account, review the transcribed rich media package, make revisions as needed, and send revisions to selected individuals, via email.

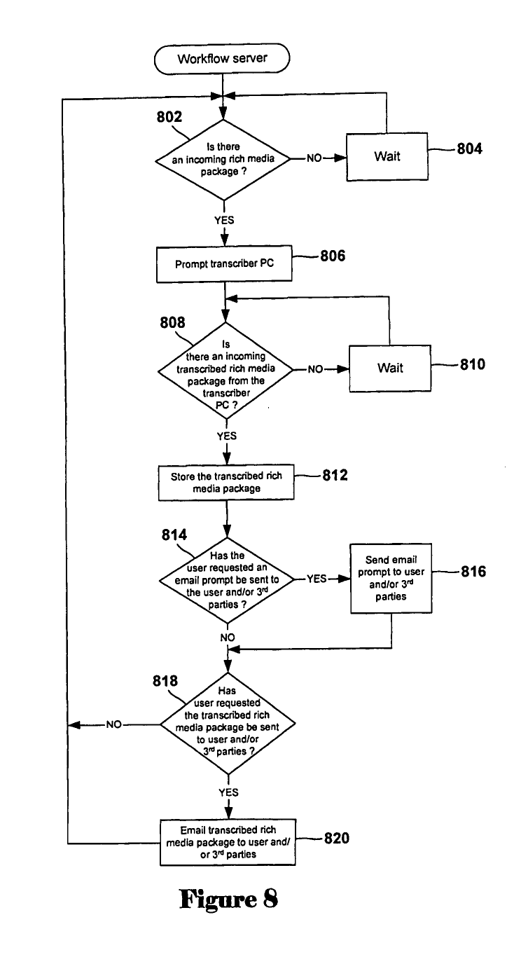

FIG. 8 shows a control-flow diagram of exemplary steps for a workflow server in a system for transferring a rich media package from a mobile device to a collaborative workflow that represents one embodiment of the present invention. When, in step 802, an incoming rich media package has not been received from a mobile device, control is passed to step 804 and the workflow server waits for a time increment and control is passed back to step 802. When, in step 802, an incoming rich media package is received from a mobile device, control is passed to step 806. In step 806, a prompt is sent to a transcriber PC alerting a transcription service of the arrival of a new rich media package and control is passed to step 808. When, in step 808, an incoming transcribed rich media package has not been received from the transcriber PC, control is passed to step 810 and the workflow server waits for a time increment and control is passed back to step 808. When, in step 808, an incoming transcribed rich media package is received from the transcriber PC, control is passed to step 812. In step 812, the input transcribed rich media package is stored on the workflow server and control is passed to step 814. When, in step 814, a user has requested that an email prompt be sent to the user and/or user-authorized third parties to alert the user and/or user-authorized third parties when the transcribed rich media package becomes accessible, control is passed to step 816. In step 816, the requested email prompt is sent to the user and/or user-authorized third parties and control is passed to step 818. When, in step 814, the user has not requested that an email prompt be sent, control is passed to step 818. When, in step 818, a user has requested that the transcribed rich media package be sent to the user and/or user-authorized third parties when the transcribed rich media package becomes accessible, control is passed to step 820. In step 820, the transcribed rich media package is emailed to the user and/or user-authorized third parties and control is passed to step 802. When, in step 818, the user has not requested that the transcribed rich media package be sent to the user and/or user-authorized third parties, control is passed to step 802.

In various embodiments of the present invention, the amount of time that a transcribed rich media package is stored on a workflow server may vary. A user may opt to delete transcribed rich media packages in a user inbox. Alternately, a user may be supplied with an option on his or her account as to how many days a transcribed rich media package is to be stored on a workflow server before being deleted. Also alternatively, a user may be contractually allowed to maintain transcribed rich media packages for a specified duration, after which time the transcribed rich media packages are automatically deleted.

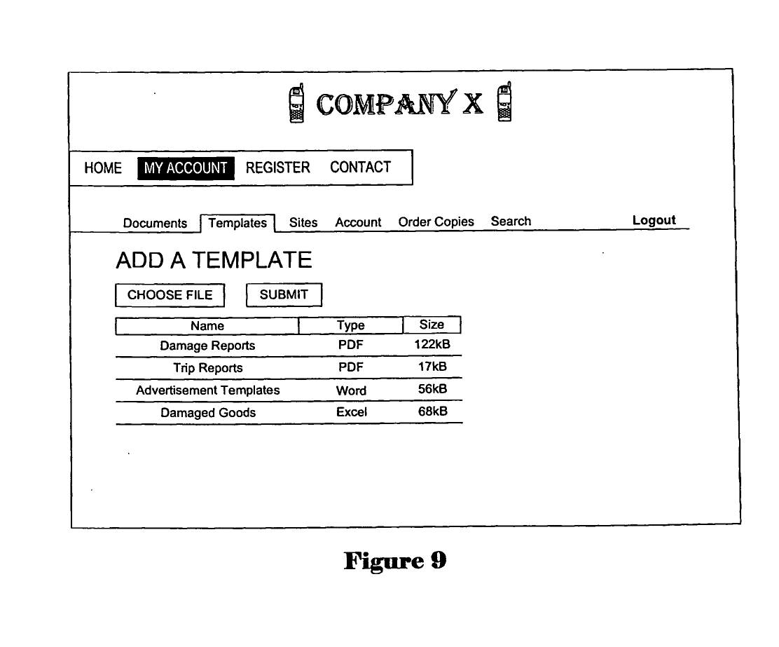

In various embodiments of the present invention, an on-line personal account may contain several pages of information related to a user's currently-available transcribed rich media packages and the user's account attributes. In one embodiment of the present invention, a user may access a personal-account page enabling templates to be uploaded by a user. The uploaded templates may be used as templates for selected transcribed rich media packages. FIG. 9 shows an exemplary on-line personal-account page containing user-selected template options for use with transcribed rich media packages that represents one embodiment of the present invention.

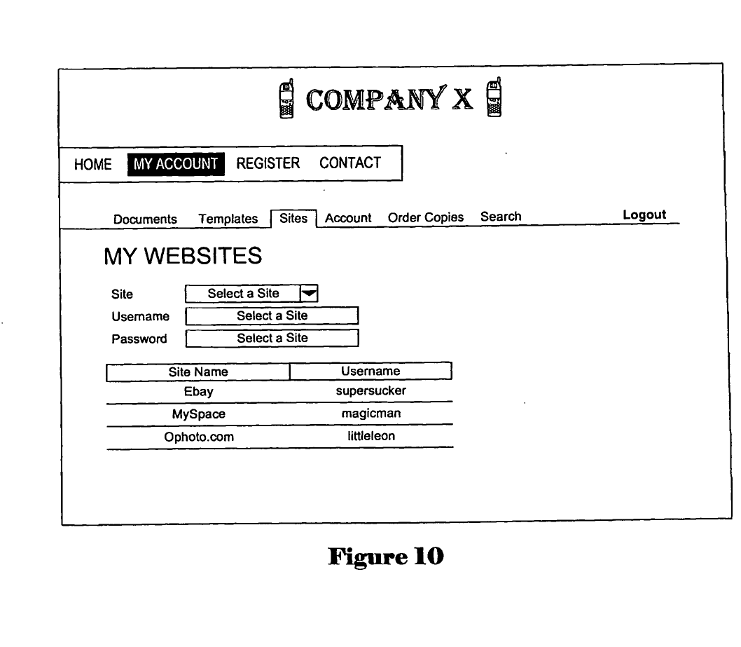

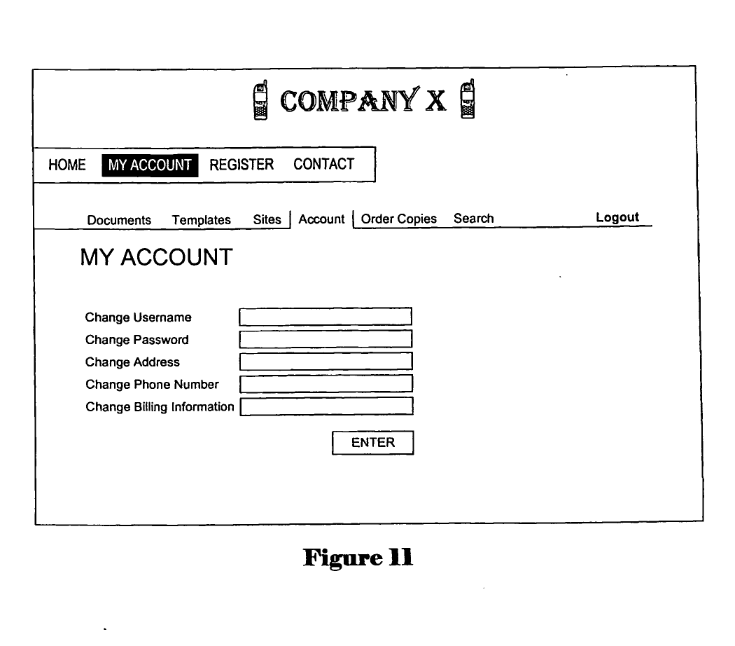

In various embodiments of the present invention, a user may access a personal-account page containing website addresses and login information that may be used to automatically send transcribed rich media packages to selected websites for uploading. FIG. 10 shows an exemplary on-line personal-account page containing user-selected destination options for uploading transcribed rich media packages that represents one embodiment of the present invention. In one embodiment of the present invention, a user may logon to the user's account and change account parameters, settings, and options. FIG. 11 shows an exemplary on-line personal-account page containing user-changeable account attributes that represents one embodiment of the present invention.

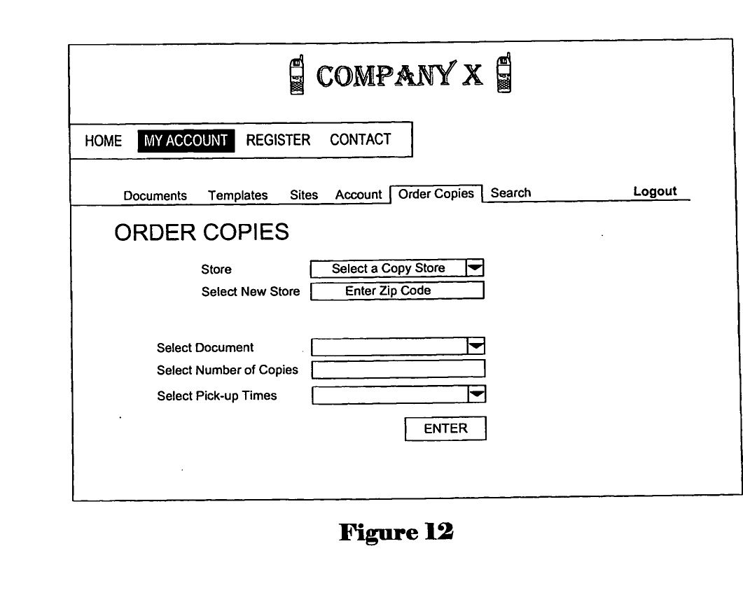

In various embodiments of the present invention, a user may elect to have a transcribed rich media package sent to a printer. In various embodiments of the present invention, the user is provided with some possible printing arrangements and delivery options. FIG. 12 shows an exemplary on-line personal-account page that a user may use to print selected transcribed rich media packages and that represents one embodiment of the present invention.

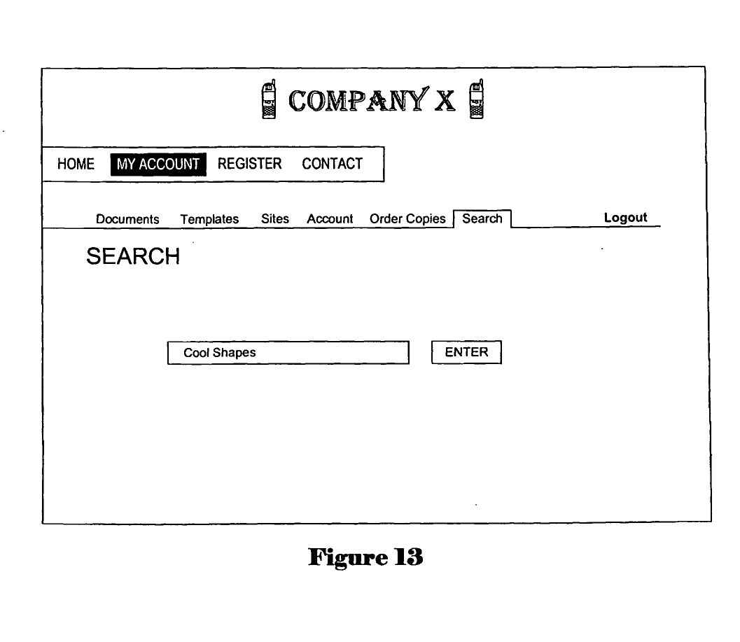

In various embodiments of the present invention, a user may perform searches to locate one or more transcribed rich media packages using, for example, a key-word search using a tag, or some other key-words. FIG. 13 shows an exemplary on-line personal-account page that enables a user to search for selected transcribed rich media packages and that represents one embodiment of the present invention. In FIG. 13, a user has entered “Cool Shapes” as a key-word search.

The present invention may be used in a variety of professional settings, including law enforcement, insurance adjustment, intelligence, land speculation, academics, surveillance, sales, construction, and other professional settings. Additionally, the present invention may be used to record important personal events and achievements, including weddings, births, reunions, graduations, recreational events, religious events, vacations, award ceremonies, and other personal events and achievements.

Additional modifications within the spirit of the invention will be apparent to those skilled in the art. For example, a voice signal may be transferred and transcribed without the inclusion of visual media. An administrator may perform all or a portion of the transcription services in addition to performing administrative services associated with the disclosed system. Rich media packages containing voice-signals and visual media may be transferred to a workflow server without being saved on a mobile device's internal persistent memory. Notification may be used instead of polling. The size (in kB) of transferable rich media packages may be limited by agreement between a user and an administrator. Rich media packages and transcribed rich media packages may be stored in intermediate storage devices. Rich media packages and transcribed rich media packages may be transferred to additional locations besides the locations shown in FIG. 1. Multiple workflow servers may be used. Transferred rich media packages need not comprise entire files. For example, metadata may be transferred instead of an entire rich media package. A number of transfers may be needed to transfer all or part of a rich media package or transcribed rich media package. Rich media packages and transcribed rich media packages downloaded to a PC and/or a workflow server may be placed in any number of different locations on the PC and/or workflow server, including multiple locations. Various securities may be implemented before and after each transfer of a rich media package and/or a transcribed rich media package from one location to another. Fees may be charged for some or all aspects of the discussed system. Additional transformations of data may occur at any point during the transfer process. Transferred rich media packages and transcribed rich media packages may include additional information, such as diagnostic information for gauging the reliability of the received rich media packages and/or transcribed rich media packages. Transcribed rich media packages may be stored in various locations with a workflow server based on a user-selected tag, folder name, or other user-selected identifier.

The foregoing detailed description, for purposes of illustration, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Obviously many modifications and variation are possible in view of the above teachings. The embodiments were chosen and described in order to best explain the principles of the invention and its practical applications and to thereby enable others skilled in the art to best utilize the invention and various embodiments with various modifications as are suited to the particular use contemplated.

1. A method for incorporating a voice-attached, tagged rich media package from a wireless handheld mobile device into a collaborative workflow, the method comprising:
providing a workflow server for receiving, storing, and transmitting the voice-attached, tagged rich media package;
receiving, by the workflow server, the voice-attached, tagged rich media package from the wireless handheld mobile device;
transmitting, by the workflow server, the voice-attached, tagged rich media package to a transcription service;
receiving, by the workflow server, a voice-attached, tagged, transcribed rich media package from the transcription service; and
storing, by the workflow server, the voice-attached, tagged, transcribed rich media package at a location that is accessible to a user and a number of user-authorized third parties.

2. The method of claim 1 wherein the voice-attached, tagged rich media package includes
a voice signal;
one or more visual media; and
one or more user-selected tags.

3. The method of claim 2 wherein voice signal is generated on the wireless handheld mobile device.

4. The method of claim 2 wherein the visual media includes one or more of
a digital image,
an animation, and
a video recording.

5. The method of claim 2 wherein the user selects the one or more tags to classify the voice-attached, tagged, transcribed rich media package.

6. The method of claim 5 wherein one or more third parties are granted authorization to the voice-attached, tagged, transcribed rich media package based on the user-selected tags.

7. The method of claim 1 wherein the wireless handheld mobile device includes a camera.

8. The method of claim 7 wherein the visual media is generated on the camera-equipped wireless handheld mobile device.

9. The method of claim 1 wherein the workflow server receives the voice-attached, tagged rich media package from the wireless handheld mobile device via a wireless network.

10. The method of claim 1 wherein the workflow server transmits the voice-attached, tagged rich media package to the transcription service via the Internet.

11. The method of claim 1 wherein the workflow server receives the voice-attached, tagged, transcribed rich media package from the transcription service via the Internet.

12. The method of claim 1 wherein the voice-attached, tagged, transcribed rich media package is accessible to the user and user-authorized third parties via the Internet.

13. The method of claim 12 wherein the voice-attached, tagged, transcribed rich media package is sent as an email attachment to one or more of
the user; and
one or more user-authorized third parties.

14. The method of claim 12 wherein the voice-attached, tagged, transcribed rich media package is accessible, via a website, to one or more of
the user; and
one or more user-authorized third parties.

15. The method of claim 14 wherein, upon receival of the voice-attached, tagged, transcribed rich media package from the transcription service, the workflow server sends an email alerting the arrival of the voice-attached, tagged, transcribed rich media package to one or more of
the user; and
one or more user-authorized third parties.

16. A system for incorporating a voice-attached, tagged rich media package from a wireless handheld mobile device into a collaborative workflow, the system comprising:
a workflow-server computer that includes memory and a processor; and
a program running on the workflow-server computer, the program
receiving the voice-attached, tagged rich media package from the wireless handheld mobile device,
transmitting the voice-attached, tagged rich media package to a transcription service,
receiving a voice-attached, tagged, transcribed rich media package from the transcription service, and
storing the voice-attached, tagged, transcribed rich media package at a location that is accessible to a user and a number of user-authorized third parties.

17. The system of claim 16 wherein the voice-attached, tagged rich media package includes
a voice signal;
one or more visual media; and
one or more user-selected tags.

18. The system of claim 16 wherein the visual media includes one or more of
a digital image,
an animation, and
a video recording.

19. The system of claim 16 wherein the user selects the one or more tags to classify the voice-attached, tagged, transcribed rich media package.

20. A system for incorporating visual images, a user-created voice signal, and user-selected tags into a collaborative workflow, the system comprising: -
a wireless-handheld-mobile-device computer that includes memory and a processor; and
a program running on the wireless-handheld-mobile-device computer, the program
generating the visual images,
storing the visual images into the memory,
creating a voice signal by a user,
storing the user-created voice signal into the memory,
storing the user-selected tags into the memory,
incorporating the visual images, the user-created voice signal, and the user-selected tags into a voice-attached, tagged rich media package, and
transmitting the voice-attached, tagged rich media package to a workflow server for storage and subsequent accessibility by the user and a number of user-authorized third parties.
